(19) United States
(12) Patent Application Publication
(10) Pub. No.: US 2010/0033957 A1
(43) Pub. Date: Feb. 11, 2010

(54) Backlight Module

(76) Inventor: Po-Iem LIN, Hsin-Chu (TW)

Correspondence Address: HDLS Patent & Trademark Services, P.O. BOX 220746, CHANTILLY, VA, 20153-0746, US

(21) Appl. No.: 12/268,522

(22) Filed: Nov. 11, 2008

(30) Foreign Application Priority Data
Aug. 6, 2008 (TW) 097129865

(51) Int. Cl. G02F 1/13357

(52) U.S. Cl. 362/97.2

(57) ABSTRACT

A backlight module includes a light source unit, a first optical plate and a second optical plate. The first optical plate is disposed above the light source unit. The first optical plate has a plurality of first light diffusion structures arranged in an array on a first surface thereof. An edge of a bottom surface of each of the first light diffusion structures is perpendicular to a first direction. The second optical plate is disposed above the first optical plate. The second optical plate has a plurality of second light diffusion structures arranged in an array on a second surface thereof. Each of the first and second light diffusion structures is formed in a pyramid shape. An edge of a bottom surface of each of the second light diffusion structures is perpendicular to a second direction. An included angle is defined between the first direction and the second direction.

### BACKGROUND

1. Technical Field

The present invention relates to a liquid crystal display (LCD), and more particularly to a backlight module used in the liquid crystal display.

2. Description of the Related Art

With the development of flat panel display technique, flat panel displays (FPDs) that have advantages of light in weight, small in size and low power consumption are becoming more and more popular. Typically, the flat panel displays include liquid crystal displays (LCDs), plasma panel displays (PDPs), organic light emitting diode displays (OLED displays) and electrophoretic displays (EPDs). Among the flat panel displays, the liquid crystal displays are most widely used.

The liquid crystal display includes a liquid crystal display panel and a backlight module. The backlight module is used to provide a plane light source to the liquid crystal display panel. Generally, the backlight module may be classified into a direct type backlight module and an edge type backlight module based on a transmission mode of light. FIG. 1 is a cross-sectional view of a conventional direct type backlight module. Referring to FIG. 1, the backlight module 100 includes a light source unit 110, a diffusion plate 120 and a diffusion film 130. The light source unit 110 includes a substrate 112 and a plurality of light emitting diodes 114 disposed on the substrate 112. The light emitting diodes 114 are used to provide light rays 115 to a light incident surface 122 of the diffusion plate 120. The diffusion plate 120 is used to diffuse the light rays 115 so as to form a plane light source 117. The diffusion film 130 is disposed above the diffusion plate 120. The diffusion film 130 is used to enhance uniformity of the plane light source 117.

In the conventional technique, there must be enough space between the light source unit 110 and the diffusion plate 120 for mixing the light rays 115. If a distance H1 between the light source unit 110 and the diffusion plate 120 is too short, the plane light source 117 would generate a visible line mura. The development trend of the liquid crystal display is toward a thin thickness, therefore, to make the backlight module 100 become thinner, the distance H1 between the light source unit 110 and the diffusion plate 120 should be reduced. In the conventional technique, to avoid the visible line mura formed due to reducing the distance H1 between the light source unit 110 and the diffusion plate 120, a plurality of dot patterns 126 are configured on the light incident surface 122 of the diffusion plate 120. However, configuring the dot patterns 126 on the light incident surface 122 to decrease the space for mixing the light rays 115 does not effectively eliminate the visible line mura.

Furthermore, the dot patterns 126 configured on the diffusion plate 120 would make an alignment of the light source unit 110 and the diffusion plate 120 become difficult. Consequently, a production efficiency of the backlight module 100 would be reduced. In addition, if the alignment of the light source unit 110 and the diffusion plate 120 is not precise enough, the visible line mura still appears in the plane light source 117.

### BRIEF SUMMARY

The present invention relates to a backlight module for providing a plane light source having improved uniformity.

To achieve the above-mentioned advantage, the present invention provides a backlight module. The backlight module includes a light source unit, a first optical plate and a second optical plate. The first optical plate is disposed above the light source unit. The first optical plate has a plurality of first light diffusion structures arranged in an array on a first surface of the first optical plate. Each of the first light diffusion structures is formed in a pyramid shape. An edge of a bottom surface of each of the first light diffusion structures is perpendicular to a first direction. The second optical plate is disposed above the first optical plate. The second optical plate has a plurality of second light diffusion structures arranged in an array on a second surface of the second optical plate. Each of the second light diffusion structures is formed in a pyramid shape. An edge of a bottom surface of each of the second light diffusion structures is perpendicular to a second direction. An included angle is defined between the first direction and the second direction.

To achieve the above-mentioned advantage, the present invention provides another backlight module. The backlight module includes a light source unit and an optical plate. The optical plate is disposed above the light source unit. The optical plate includes a light incident surface and a light emitting surface opposite to the light incident surface. The light incident surface faces the light source unit. A plurality of first light diffusion structures are arranged in an array on the light incident surface. Each of the first light diffusion structures is formed in a pyramid shape. An edge of a bottom surface of each of the first light diffusion structures is perpendicular to a first direction. A plurality of second light diffusion structures are arranged in an array on the light emitting surface. Each of the second light diffusion structures is formed in a pyramid shape. An edge of a bottom surface of each of the second light diffusion structures is perpendicular to a second direction. An included angle is defined between the first direction and the second direction.

In one of the backlight modules of the present invention, the light rays provided by the light source unit can be effectively diffused by the first light diffusion structures of the first optical plate and the second diffusion structures of the second optical plate, and thus the backlight module can provide the plane light source having the improved uniformity. In another backlight modules of the present invention, the light rays provided by the light source unit can be effectively diffused by the first light diffusion structures on the light incident surface of the optical plate and the second diffusion structures on the light emitting surface of the optical plate, and thus the backlight module can provide the plane light source having the improved uniformity.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional view of a conventional direct type backlight module.

FIG. 2 is a cross-sectional view of a backlight module according to an exemplary embodiment of the present invention.

FIG. 3 is a three-dimensional view showing a first optical plate structure and a second optical plate structure of the backlight module shown in FIG. 2.

FIG. 4 is a schematic view of a first light diffusion structure and a second light diffusion structure, showing the first light diffusion structure and the second light diffusion structure respectively diffusing light rays along various directions.

FIG. 5 is a three-dimensional view showing the structure of the first optical plate and the second optical plate according to another exemplary embodiment of the present invention.

FIG. 6 is a cross-sectional view of a backlight module according to another exemplary embodiment of the present invention.

FIG. 7 is a cross-sectional view of a backlight module according to another exemplary embodiment of the present invention.

FIG. 8A is a bottom view showing the part structure of an optical plate of the backlight module of FIG. 7.

FIG. 8B is a top view showing the part structure of the optical plate of the backlight module of FIG. 7.

FIG. 9 is a cross-sectional view of a backlight module according to another exemplary embodiment of the present invention.

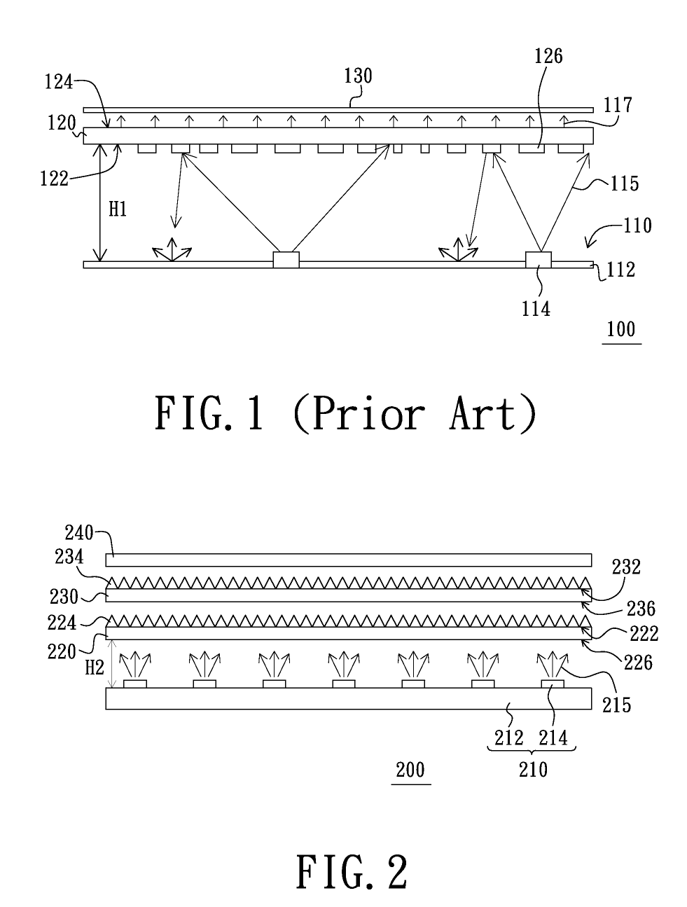

### DETAILED DESCRIPTION

Reference will now be made to the drawings to describe various exemplary embodiments of the present backlight module in detail.

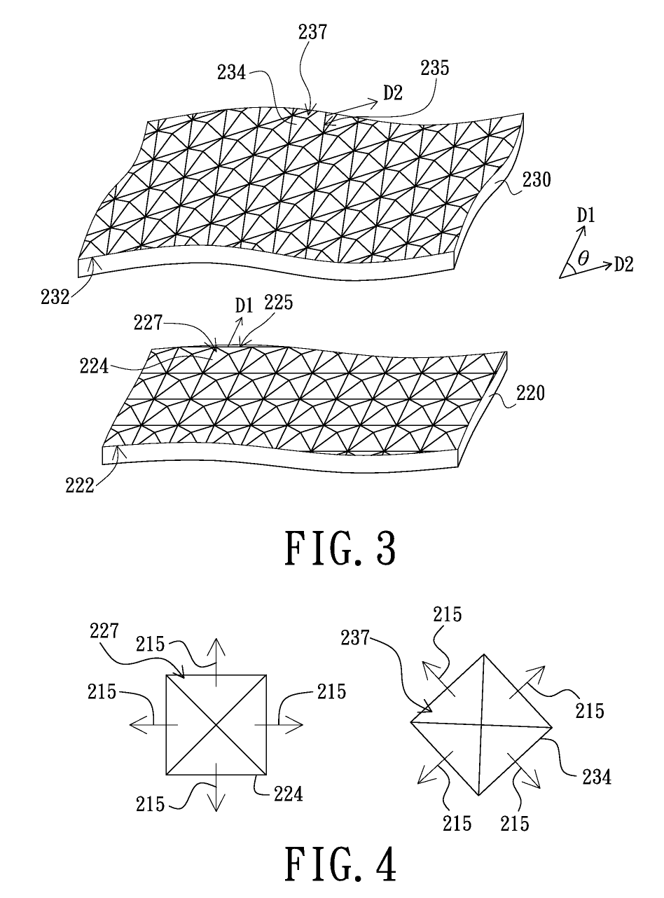

FIG. 2 is a cross-sectional view of a backlight module according to an exemplary embodiment of the present invention. FIG. 3 is a three-dimensional view showing a first optical plate structure and a second optical plate of the backlight module shown in FIG. 2. Referring to FIGS. 2 and 3, the backlight module 200 includes a light source unit 210, a first optical plate 220 and a second optical plate 230. The first optical plate 220 is disposed above the light source unit 210, and the second optical plate 230 is disposed above the first optical plate 220. The first optical plate 220 has a plurality of first light diffusion structures 224 arranged in an array on a first surface 222 of the first optical plate 220. Each of the first light diffusion structures 224 is formed in a pyramid shape. An edge 225 of a bottom surface of each of the first light diffusion structures 224 is perpendicular to a first direction D1. The second optical plate 230 has a plurality of second light diffusion structures 234 arranged in an array on a second surface 232 of the second optical plate 230. Each of the second light diffusion structures 234 is formed in a pyramid shape. An edge 235 of a bottom surface of each of the second light diffusion structures 234 is perpendicular to a second direction D2. An included angle θ is defined between the first direction D1 and the second direction D2.

The backlight module 200 can include a diffusion plate 240 disposed above the second optical plate 230, and further include an optical film (not shown) disposed above the diffusion plate 240. In addition, the light source unit 210 can include a substrate 212 and a plurality of light emitting diodes 214 arranged in an array on the substrate 212. The light emitting diodes 214 are used to provide light rays 215 to the first optical plate 220. The first surface 222 can be a light emitting surface of the first optical plate 220. The second surface 232 can be a light emitting surface of the second optical plate 230. The first optical plate 220 has a light incident surface 226 opposite to the light emitting surface (i.e. the first surface 222) of the first optical plate 220. The second optical plate 230 has a light incident surface 236 opposite to the light emitting surface (i.e. the second surface 232) of the second optical plate 230. In the embodiment, when the first surface 222 and the second surface 232 are both light emitting surfaces, the light incident surface 226 of the first optical plate 220 and the light incident surface 236 of the second optical plate 230 can be haze surfaces or polished surfaces, or have microstructures (such as thin stripes) thereon.

Each of the first light diffusion structures 224 formed in the pyramid shape can be protrusions that are protruded out from the first surface 222. Each of the second light diffusion structures 234 formed in the pyramid shape can be protrusions that are protruded out from the second surface 232. The first light diffusion structures 224 and the second light diffusion structures 234 have the same shapes. As will be described in detail below, the first light diffusion structures 224 and the second light diffusion structures 234 have the same shapes, which are such as quadrangular pyramids in shape. The first light diffusion structures 224 abut against each other on the first surface 222. The second light diffusion structures 234 abut against each other on the second surface 232. In addition, the included angle θ defined between the first direction D1 and the second direction D2 can be in the range from 10 degrees to 80 degrees. In another word, the first light diffusion structures 224 and the second light diffusion structures 234 are disposed in different orientations. In a preferable embodiment, the included angle θ defined between the first direction D1 and the second direction D2 is about 45 degrees.

FIG. 4 is a schematic view of a first light diffusion structure and a second light diffusion structure, showing the first light diffusion structure and the second light diffusion structure respectively diffusing light rays along various directions. Referring to FIGS. 2 to 4, in the embodiment, the light rays 215 that enter the first optical plate 220 would emit from inclined surfaces 227 of the first light diffusion structures 224, thus the light rays 215 can be effectively diffused by the first light diffusion structures 224. Furthermore, the light rays 215 that enter the second optical plate 230 would emit from inclined surfaces 237 of the second light diffusion structures 234, thus the light rays 215 can be effectively diffused by the second light diffusion structures 234. In addition, the first light diffusion structures 224 and the second light diffusion structures 234 are disposed in different orientations, thus the first light diffusion structure 224 and the second light diffusion structure 234 can respectively diffuse light along various directions. As such, a light diffusion effect is further improved. Therefore, when compared with the conventional technique, the backlight module 200 can provide a plane light source having better uniformity. Furthermore, because the first optical plate 220 and the second optical plate 230 may provide the improved light diffusion effect, a distance H2 between the light source unit 210 and the first optical plate 220 can be reduced, and thus thickness of the backlight module 200 can be reduced. In addition, when the backlight module 200 is assembled, the light source unit 210, an alignment of the first optical plate 220 and the second optical plate 230 does not require high precision. Thus a production efficiency of the backlight module 200 is improved, and production cost of the backlight module 200 is consequently decreased.

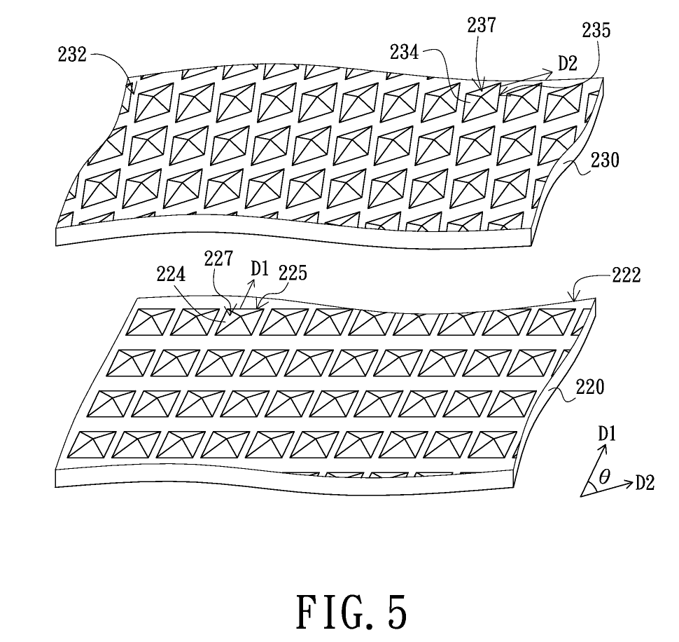

It should be noted that, in the backlight module 200, even if a quantity of the light emitting diodes 214 is decreased properly, a visible line mura does not appear in the plane light source provided by the backlight module 200. It is understood that, the first light diffusion structures 224 and the second light diffusion structures 234 have the same shapes in this embodiment, but in other embodiments, the first light diffusion structures 224 and the second light diffusion structures 234 can have different shapes. In another embodiment, referring to FIG. 5, the first light diffusion structures 224 can be separated from each other on the first surface 222 of the first optical plate 220. The second light diffusion structures 234 can be separated from each other on the second surface 232 of the second optical plate 230.

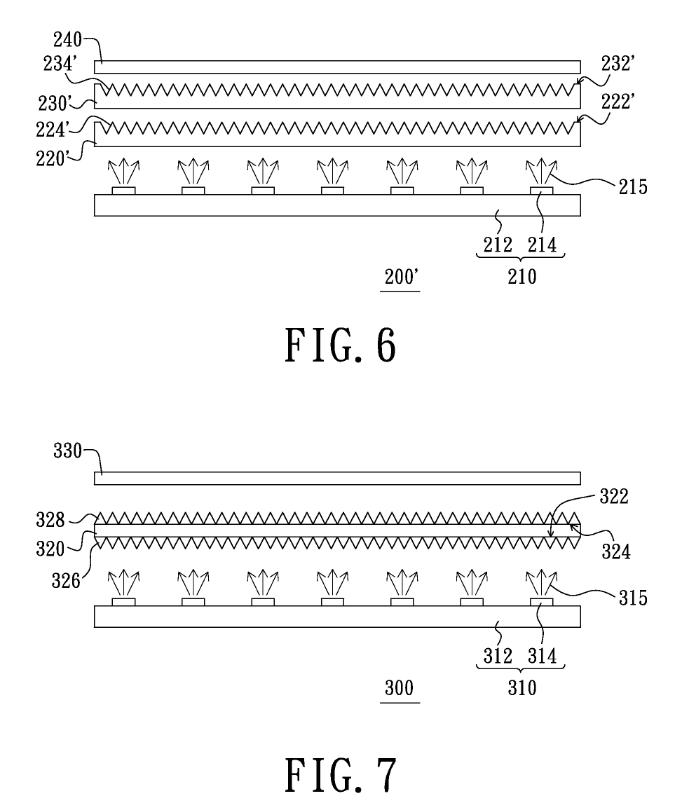

FIG. 6 is a cross-sectional view of a backlight module according to another exemplary embodiment of the present invention. Referring to FIG. 6, the structure of the backlight module 200′ is similar to that of the backlight module 200 in FIG. 2 and the difference is the first light diffusion structures 224 and 224′ and the light diffusion structures 234 and 234′. As will be described in detail below, in the backlight module 200′, the first light diffusion structures 224′ formed in the pyramid shape on the first surface 222′ of the first optical plate 220′ are concaves that are concaved in the first surface 222′, and the second light diffusion structures 234′ formed in the pyramid shape on the second surface 232′ of the second optical plate 230′ are concaves that are concaved in the second surface 232′.

In other words, in the present invention, the first light diffusion structures formed in the pyramid shape of the first optical plate can be protruded out from the first surface or concaved in the first surface, and the second light diffusion structures formed in the pyramid shape of the second optical plate can be protruded out from the second surface or concaved in the second surface.

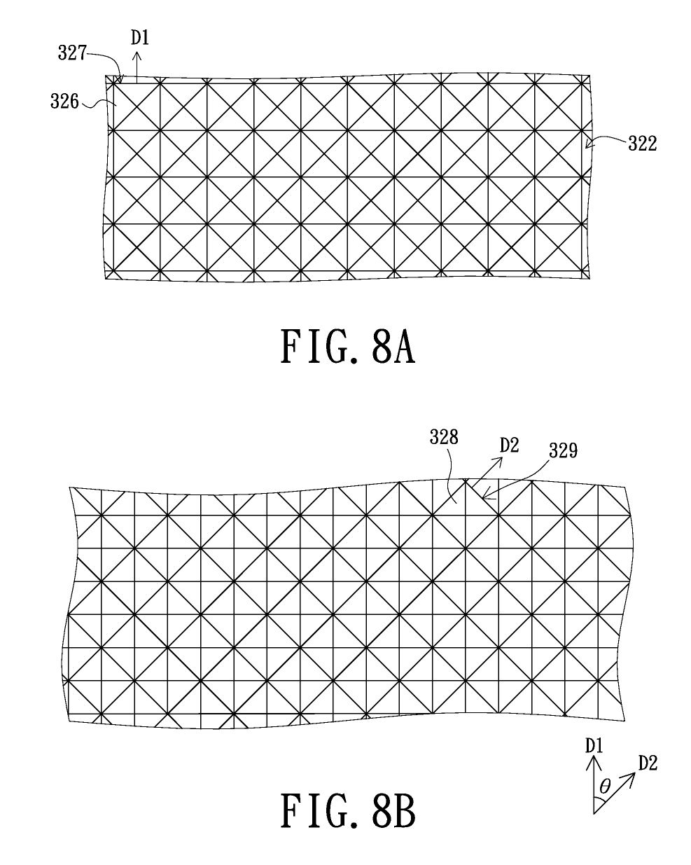

FIG. 7 is a cross-sectional view of a backlight module according to another exemplary embodiment of the present invention. FIG. 8A is a bottom view showing the part structure of an optical plate of the backlight module of FIG. 7. FIG. 8B is a top view showing the part structure of the optical plate of the backlight module of FIG. 7. Referring to FIGS. 7 to 8B, the backlight module 300 includes a light source unit 310 and an optical plate 320. The optical plate 320 is disposed above the light source unit 310. The optical plate 320 includes a light incident surface 322 and a light emitting surface 324 opposite to the light incident surface 322. The light incident surface 322 faces the light source unit 310. A plurality of first light diffusion structures 326 is arranged in an array on the light incident surface 322. Each of the first light diffusion structures 326 is formed in a pyramid shape. An edge 327 of a bottom surface of each of the first light diffusion structures 326 is perpendicular to a first direction D1. A plurality of second light diffusion structures 328 is arranged in an array on the light emitting surface 324. Each of the second light diffusion structures 328 is formed in a pyramid shape. An edge 329 of a bottom surface of each of the second light diffusion structures 328 is perpendicular to a second direction D2. An included angle θ is defined between the first direction D1 and the second direction D2.

The backlight module 300 can include a diffusion plate 330 disposed above the optical plate 320, and further include an optical film (not shown) disposed above the diffusion plate 330. In addition, the light source unit 310 can include a substrate 312 and a plurality of light emitting diodes 314 arranged in an array on the substrate 312. The light emitting diodes 314 are used to provide light rays 315 to the optical plate 320. The first light diffusion structures 326 can be the same as the first light diffusion structures 224 in FIG. 3. The second light diffusion structures 328 can be the same as the second light diffusion structures 234 in FIG. 3. In other words, the first light diffusion structures 326 and the second light diffusion structures 328 have the same shapes, which are such as quadrangular pyramids in shape. The first light diffusion structures 326 abut against each other on the light incident surface 322. The second light diffusion structures 328 abut against each other on the light emitting surface 324.

The included angle θ defined between the first direction D1 and the second direction D2 is in the range from 10 degrees to 80 degrees. In another word, the first light diffusion structures 326 and the second light diffusion structures 328 are disposed in different orientations. In a preferable embodiment, the included angle θ defined between the first direction D1 and the second direction D2 is about 45 degrees.

The backlight module 300 has the advantages similar to that of the backlight module 200. In addition, in this embodiment, the first light diffusion structures 326 and the second light diffusion structures 328 can have different shapes. The first light diffusion structures 326 can be separated from each other on the light incident surface 322. The second light diffusion structures 328 can be separated from each other on the light emitting surface 324.

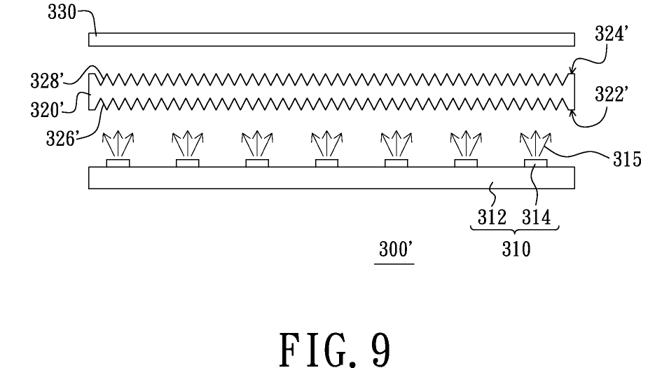

FIG. 9 is a cross-sectional view of a backlight module according to another exemplary embodiment of the present invention. Referring to FIG. 9, the structure of the backlight module 300′ is similar to that of the backlight module 300 in FIG. 7 and the difference is the first light diffusion structures 326 and 326′ and the light diffusion structures 328 and 328′. As will be described in detail below, in the backlight module 300′, the first light diffusion structures 326′ formed in the pyramid shape on the light incident surface 322′ of the optical plate 320′ are concaves that are concaved in the light incident surface 322′, and the second light diffusion structures 328′ formed in the pyramid shape on the light emitting surface 324′ of the optical plate 320′ are concaves that are concaved in the light emitting surface 324′.

In other words, in the present invention, the first light diffusion structures formed in the pyramid shape of the light incident surface of the optical plate can be protruded out from the first surface or concaved in the light incident surface, and the second light diffusion structures formed in the pyramid shape of the light emitting surface of the optical plate can be protruded out from the second surface or concaved in the light emitting surface.

In summary, the backlight module of the present invention has at least the following advantages.

1. In the backlight module of the present invention, the light provided by the light source unit can be effectively diffused by the first light diffusion structures and the second diffusion structures. Thus, the backlight module can provide the plane light source having better uniformity and the thickness of the backlight module can be reduced.

2. When the backlight module of the present invention is assembled, the backlight module does not require high alignment precision. Thus, the production efficiency of the backlight module is improved, and the production cost of the backlight module is consequently decreased.

3. The quantity of the light emitting diodes used in the backlight module of the present invention can be effectively decreased.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A backlight module comprising:
a light source unit;
a first optical plate disposed above the light source unit, the first optical plate having a plurality of first light diffusion structures arranged in an array on a first surface of the first optical plate, each of the first light diffusion structures being formed in a pyramid shape, and an edge of a bottom surface of each of the first light diffusion structures being perpendicular to a first direction; and
a second optical plate disposed above the first optical plate, the second optical plate having a plurality of second light diffusion structures arranged in an array on a second surface of the second optical plate, each of the second light diffusion structures being formed in a pyramid shape, an edge of a bottom surface of each of the second light diffusion structures being perpendicular to a second direction, and an included angle being defined between the first direction and the second direction.

2. The backlight module as claimed in claim 1, wherein the first surface is a light emitting surface of the first optical plate, and the second surface is a light emitting surface of the second optical plate.

3. The backlight module as claimed in claim 2, wherein the first optical plate comprises a light incident surface opposite to the light emitting surface of the first optical plate, and the second optical plate comprises a light incident surface opposite to the light emitting surface of the second optical plate, and each of the light incident surfaces of the first optical plate and the second optical plate is a haze surface or a polished surface, or has microstructures thereon.

4. The backlight module as claimed in claim 1, wherein the first light diffusion structures formed in the pyramid shape are protruded out from the first surface or concaved in the first surface, and the second light diffusion structures formed in the pyramid shape are protruded out from the second surface or concaved in the second surface.

5. The backlight module as claimed in claim 1, wherein the first light diffusion structures and the second light diffusion structures have the same shapes.

6. The backlight module as claimed in claim 5, wherein the first light diffusion structures and the second light diffusion structures are quadrangular pyramids in shape.

7. The backlight module as claimed in claim 6, wherein the included angle defined between the first direction and the second direction is in the range from 10 degrees to 80 degrees.

8. The backlight module as claimed in claim 7, wherein the included angle defined between the first direction and the second direction is 45 degrees.

9. The backlight module as claimed in claim 1, wherein the first light diffusion structures abut against each other on the first surface.

10. The backlight module as claimed in claim 1, wherein the first light diffusion structures are separated from each other on the first surface.

11. The backlight module as claimed in claim 1, wherein the second light diffusion structures abut against each other on the second surface.

12. The backlight module as claimed in claim 1, wherein the second light diffusion structures are separated from each other on the second surface.

13. The backlight module as claimed in claim 1, wherein the light source unit comprises a plurality of light emitting diodes arranged in an array.

14. The backlight module as claimed in claim 1, further comprising a diffusion plate disposed above the second optical plate.

15. A backlight module comprising:
a light source unit; and
an optical plate disposed above the light source unit, the optical plate including a light incident surface and a light emitting surface opposite to the light incident surface, the light incident surface facing the light source unit, a plurality of first light diffusion structures being arranged in an array on the light incident surface, each of the first light diffusion structures being formed in a pyramid shape, an edge of a bottom surface of each of the first light diffusion structures being perpendicular to a first direction, a plurality of second light diffusion structures being arranged in an array on the light emitting surface, each of the second light diffusion structures being formed in a pyramid shape, an edge of a bottom surface of each of the second light diffusion structures being perpendicular to a second direction, and an included angle being defined between the first direction and the second direction.

16. The backlight module as claimed in claim 15, wherein the first light diffusion structures formed in the pyramid shape are protruded out from the light incident surface or concaved in the light incident surface, and the second light diffusion structures formed in the pyramid shape are protruded out from the light emitting surface or concaved in the light emitting surface.

17. The backlight module as claimed in claim 15, wherein the first light diffusion structures and the second light diffusion structures have the same shapes.

18. The backlight module as claimed in claim 17, wherein the first light diffusion structures and the second light diffusion structures are quadrangular pyramids in shape.

19. The backlight module as claimed in claim 18, wherein the included angle defined between the first direction and the second direction is in the range from 10 degrees to 80 degrees.

20. The backlight module as claimed in claim 19, wherein the included angle defined between the first direction and the second direction is 45 degrees.

21. The backlight module as claimed in claim 15, wherein the first light diffusion structures abut against each other on the light incident surface.

22. The backlight module as claimed in claim 15, wherein the first light diffusion structures are separate from each other on the light incident surface.

23. The backlight module as claimed in claim 15, wherein the second light diffusion structures abut against each other on the light emitting surface.

24. The backlight module as claimed in claim 15, wherein the second light diffusion structures are separate from each other on the light emitting surface.

25. The backlight module as claimed in claim 15, wherein the light source unit comprises a plurality of light emitting diodes arranged in an array.

26. The backlight module as claimed in claim 15, further comprising a diffusion plate disposed above the light emitting surface of the optical plate.
